(19) United States
(12) Patent Application Publication
(10) Pub. No.: US 2004/0074856 A1
(43) Pub. Date: Apr. 22, 2004

(54) Slider tire chain hanger

(76) Inventor: Eugene W. Gros, Eagle Point, OR (US)

Correspondence Address: Eugen W. Gros, 7905 Agate Rd., White City, OR, 97503, US

(21) Appl. No.: 10/278,351

(22) Filed: Oct. 22, 2002

(51) Int. Cl. B42F 1/00

(52) U.S. Cl. 211/59.1; 211/4; 211/13.1

(57) ABSTRACT

The Slider Chain Hanger is a new invention. The main difference between this new invention and prior inventions of like tire chain hangers is that the Slider Chain Hanger features a single sliding door that opens with no clearance needed above the chain hanger. Other chain hangers have only one door that requires a significant amount of clearance to open, a removable door that gets left behind or falls off if not properly secured or the entire chain hanger slides not just the door.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

Basically, the invention consists of a structure that is used to carry tire chains that are mounted on the frame of a motor vehicle or semi tractor. The main difference from other tire chain hangers is the way the door opens. The Slider Tire Chain Hanger features a single sliding door that allows for convenient access to either side of the tire chain hanger. It requires no clearance above the chain hanger to open and access the tire chains. The single door slides out laterally and then pivots down, moving completely out of the way to access the tire chains. Many trailers being pulled or flatbeds mounted on a truck will only allow a minimal amount of space to access items bolted to the frame of a truck such as a tire chain hanger. The standard chain hanger produced by other manufacturers has only one door that opens up in order to access the tire chains and requires a significant amount of

### BACKGROUND OF THE INVENTION CONTINUED

clearance space in order to open the door. Before this invention drivers may not have been able to mount a chain hanger or may not have had full access to the tire chains in the hanger because of this limited clearance. Another standard chain hanger produced requires that the door be completely removed in order to access the tire chains; thus having the potential of being left behind or falling off during transit if not secured properly (Note that Pro-Tech's brochure also acknowledges this fact).

In accordance with my statutory duty of disclosure, brochures depicting tire chain hangers presently being made and sold are enclosed. Also enclosed are fourteen black line drawings of the Slider Tire Chain Hanger containing all possible views.

### BRIEF SUMMARY OF THE INVENTION

As mentioned earlier the Slider Tire Chain Hanger mounts onto the frame of a motor vehicle and is used to carry tire chains that may be needed in severe weather conditions. The Slider Tire Chain Hanger features a unique sliding door that allows it to be opened with no clearance above it leaving both sides of the chain hanger easily accessible.

### BRIEF DESCRIPTION OF THE SEVERAL VIEWS OF THE DRAWING

FIG. 1—Is a perspective view of the Slider Chain Hanger with the lid closed.

FIG. 2—Is a perspective view of the Slider Chain Hanger with the lid open.

FIG. 3—Is a front elevation view of the Slider Chain Hanger with the lid closed.

FIG. 4—Is a front elevation view of Slider Chain Hanger with the lid open.

FIG. 5—Is a back elevation view of the Slider Chain Hanger with the lid closed.

FIG. 6—Is a back elevation view of the Slider Chain Hanger with the lid open.

FIG. 7—Is a left side elevation view of the Slider Chain Hanger with the lid closed.

FIG. 8—Is a left side elevation view of the Slider Chain Hanger with the lid open.

FIG. 9—Is a right side elevation view of the Slider Chain Hanger with the lid closed.

FIG. 10—Is a right side elevation view of the Slider Chain Hanger with the doors open.

FIG. 11—Is a top plan view of the Slider Chain Hanger with the lid closed.

FIG. 12—Is a top plan view of the Slider Chain Hanger with the lid open.

### BRIEF DESCRIPTION OF THE SEVERAL VIEWS OF THE DRAWING CONTINUED

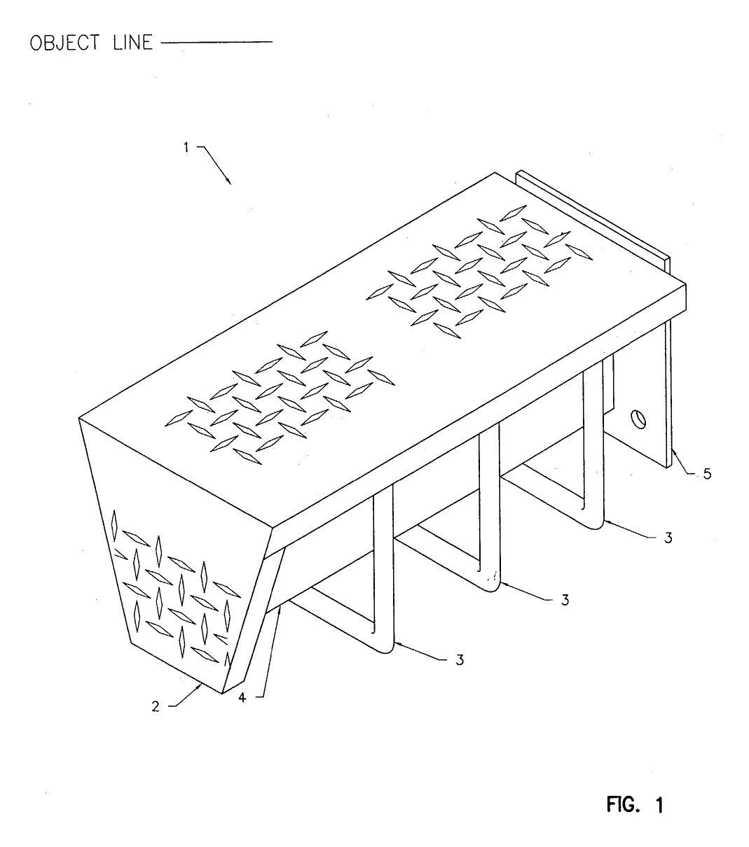

FIG. 1—Is a bottom plan view of the Slider Chain Hanger with the lid closed.

FIG. 14—Is a bottom plan view of the Slider Chain Hanger with the doors open.

### DETAILED DESCRIPTION OF THE INVENTION

For the purpose of promoting an understanding of the principles of the invention reference will now be made to the drawings and specific language will be used to describe the same. It will, nevertheless, be understood that no limitation of the scope of the invention is thereby intended.

The Slider Tire Chain Hanger 1 of the present invention is for mounting on the frame of a motor vehicle (not shown) to hang and secure tire chains onto. Referring initially to FIG. 1, Slider Tire Chain Hanger 1 is illustrated showing the lid closed. The Slider Tire Chain Hanger 1 includes: Sliding drop down lid 2 used to access the tire chain hooks 3, support tube and frame 4 used to secure the tire chain hooks 3, mount plate 5, and door rod guide 7.

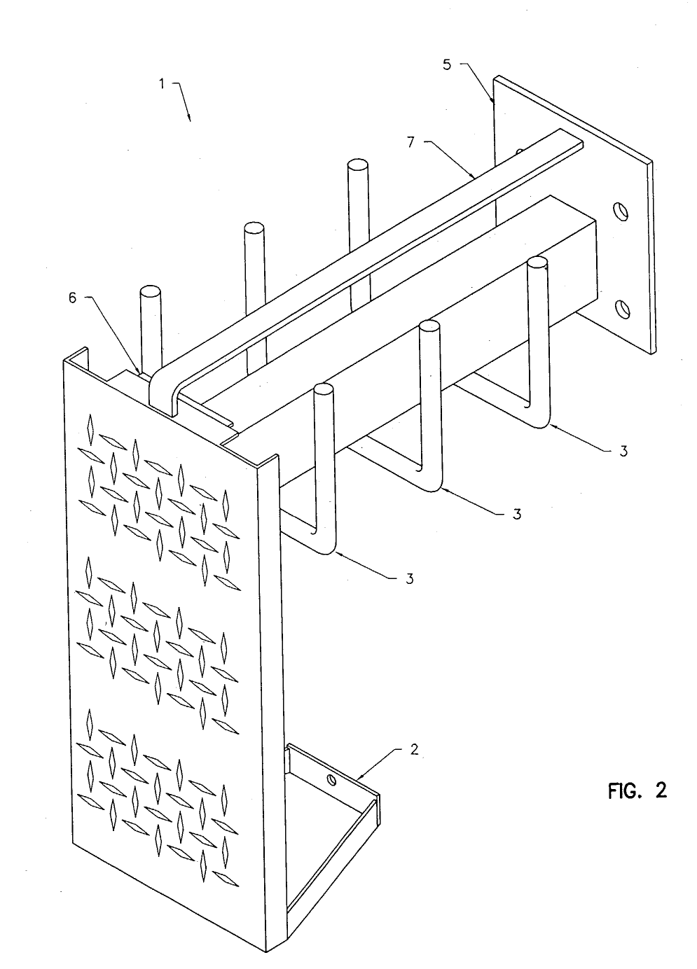

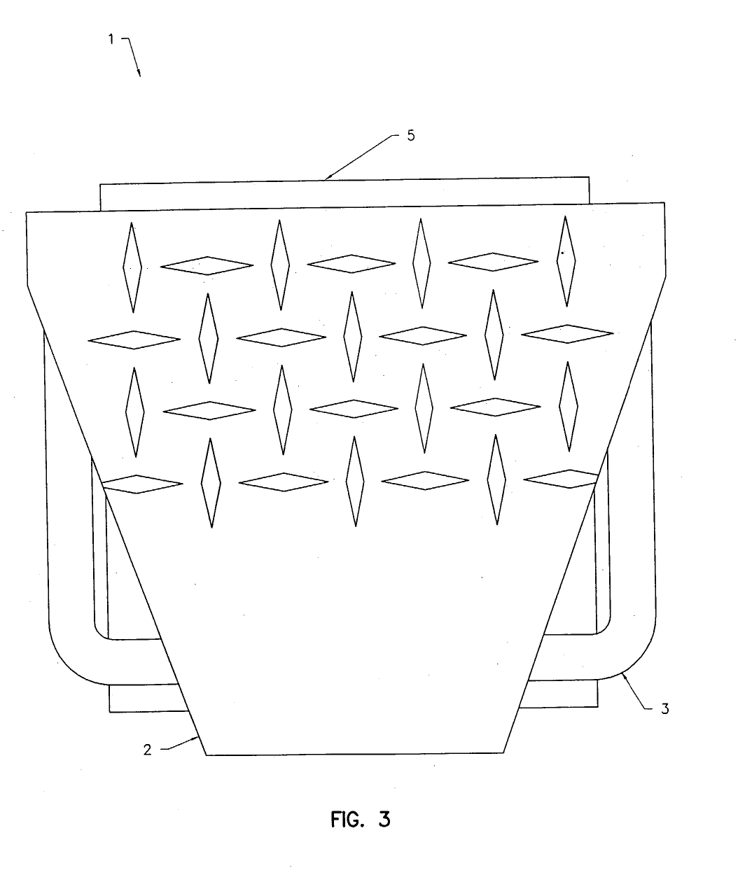

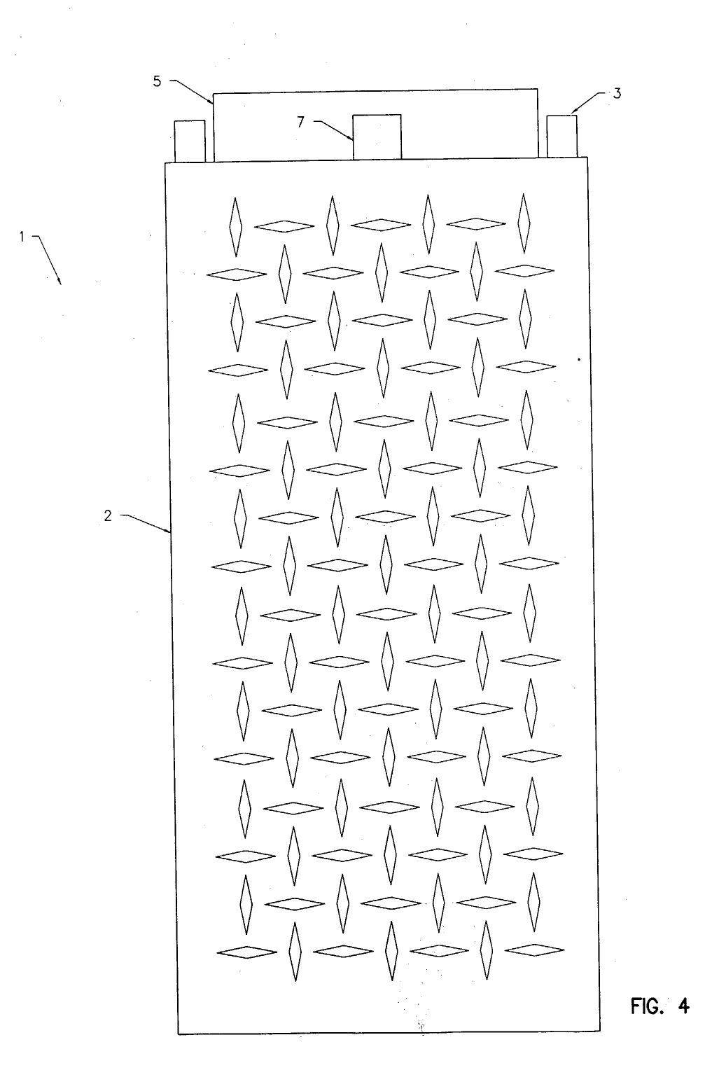

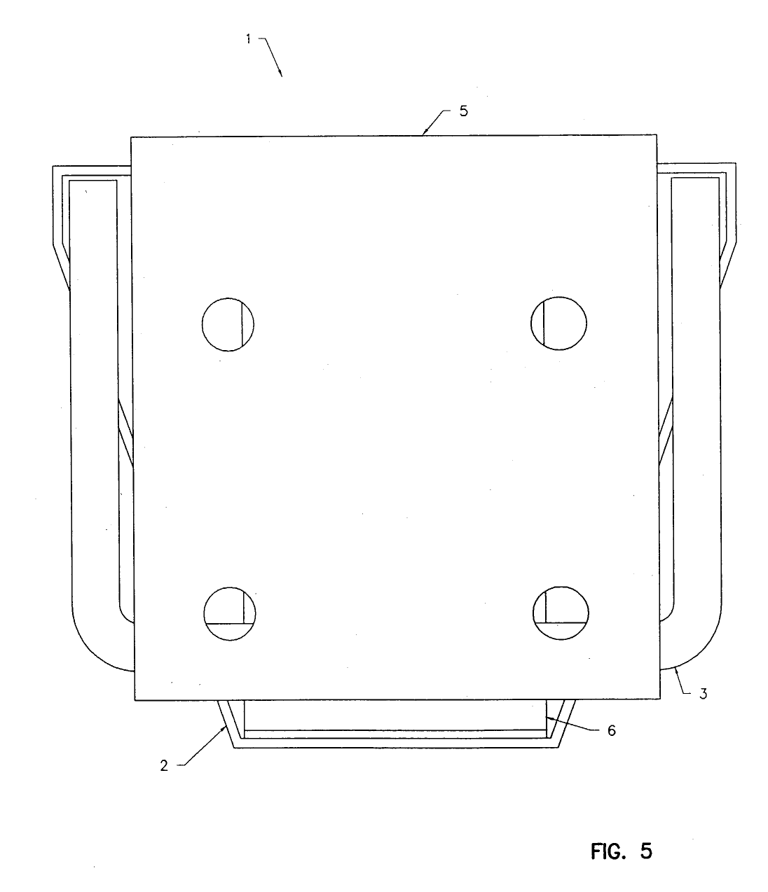

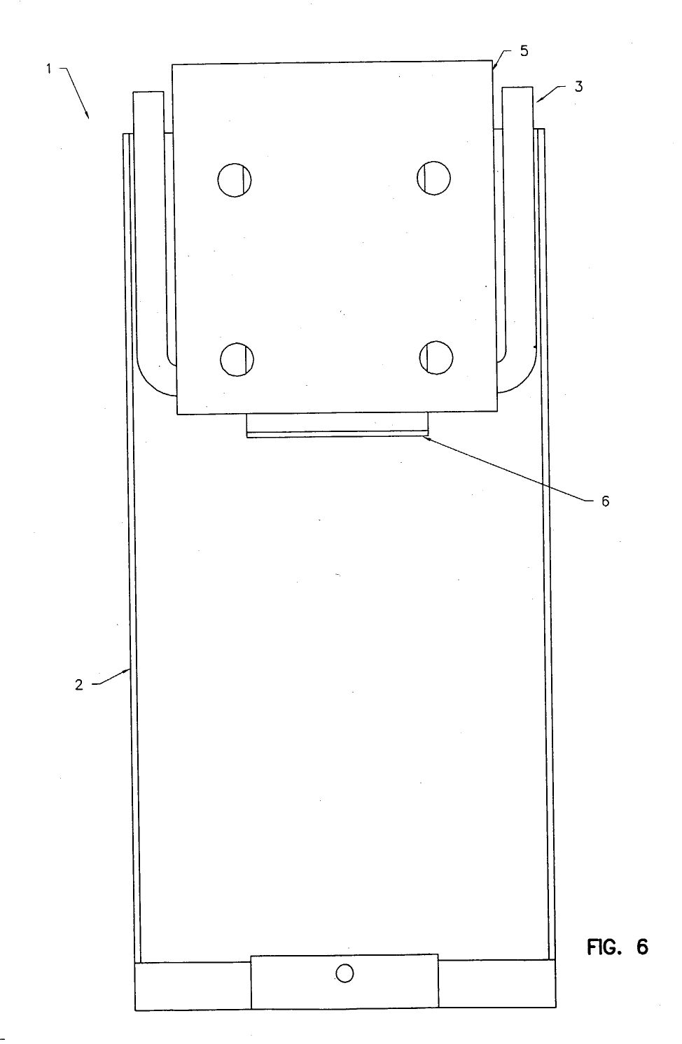

FIG. 2 illustrates the Slider Tire Chain Hanger 1 with the sliding lid 2 open. With the lid open the driver has easy access to the tire chains and needs no clearance above the chain hanger to open the lid. When the lid is open as shown in FIG. 2 the tire chain hooks 3 are easily accessible. FIG. 2 also illustrates the door rod guide 7 that the sliding lid 2 slides on and is attached to and the front plate 6 that supports the door rod guide 7.

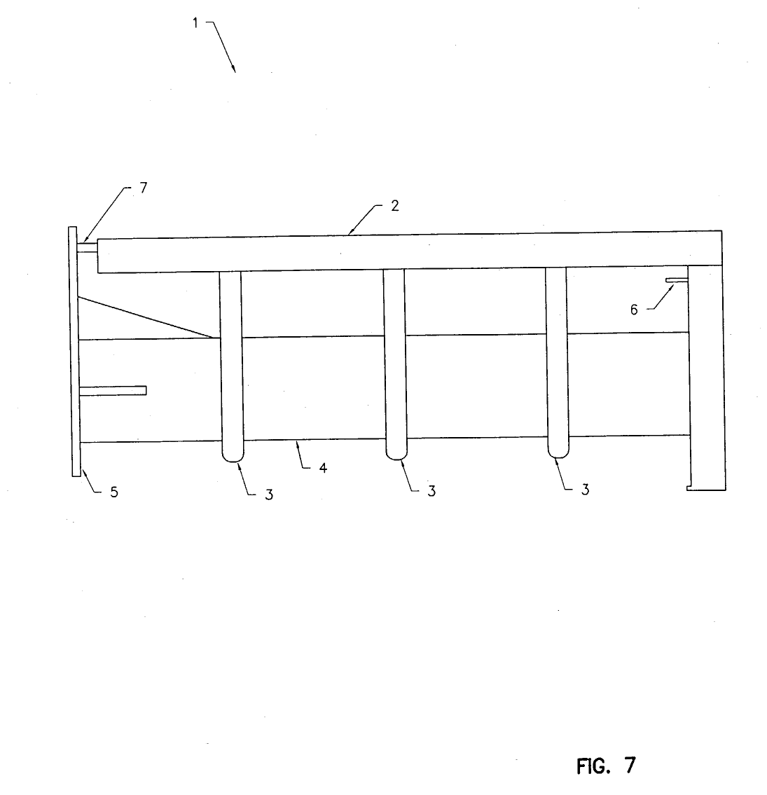

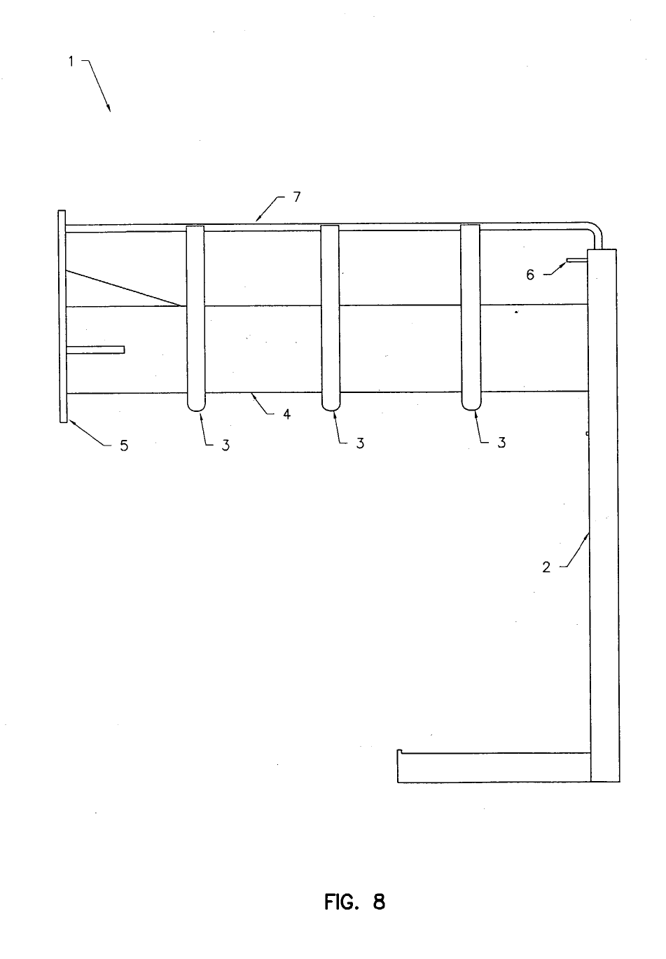

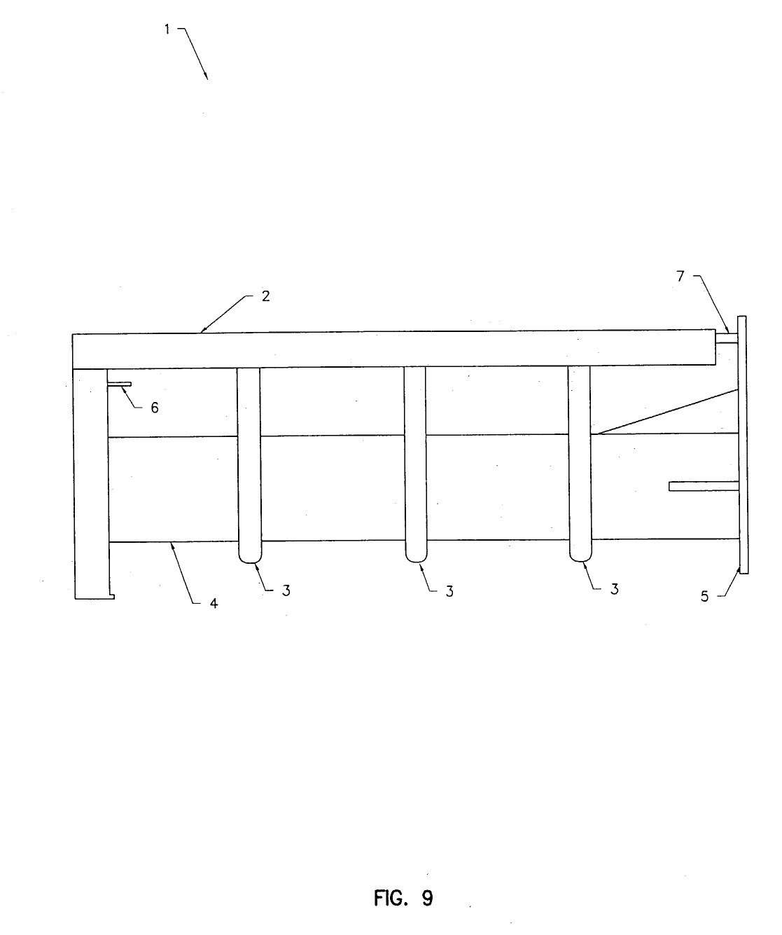

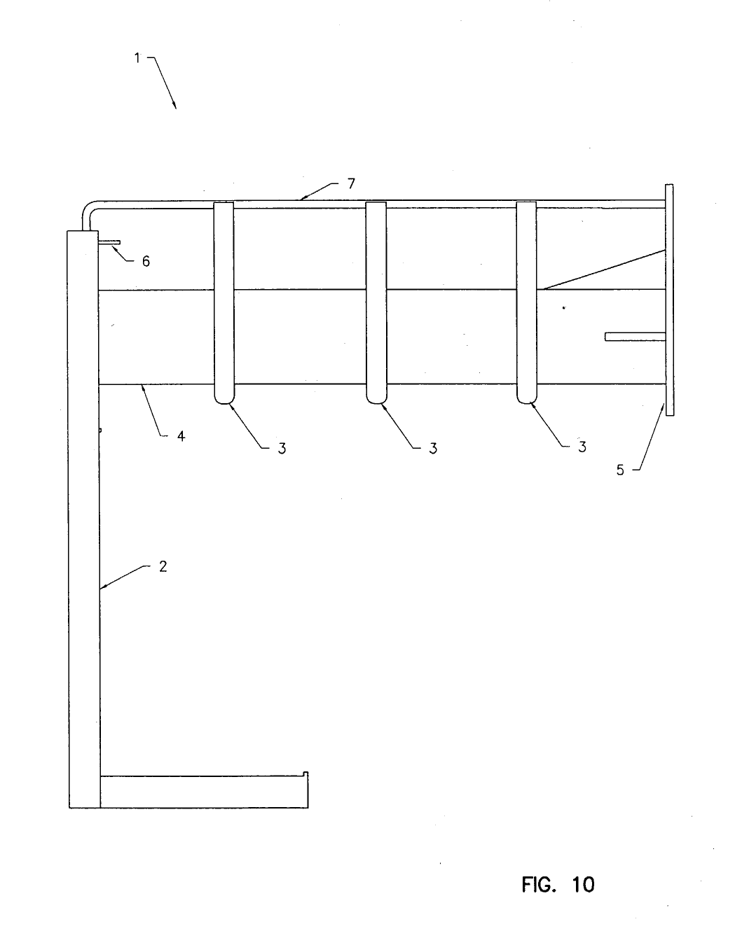

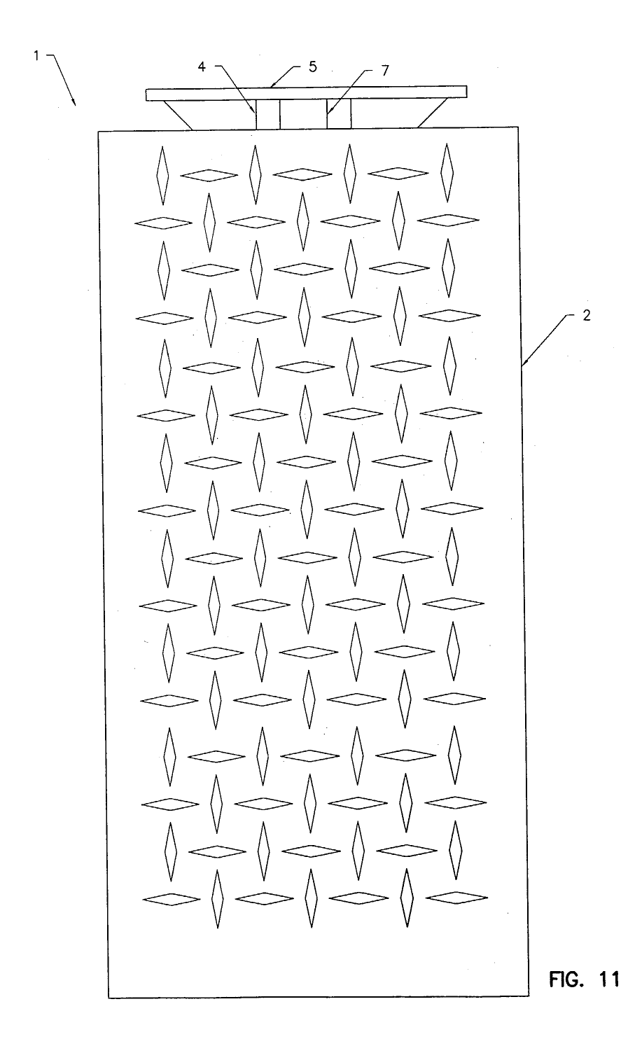

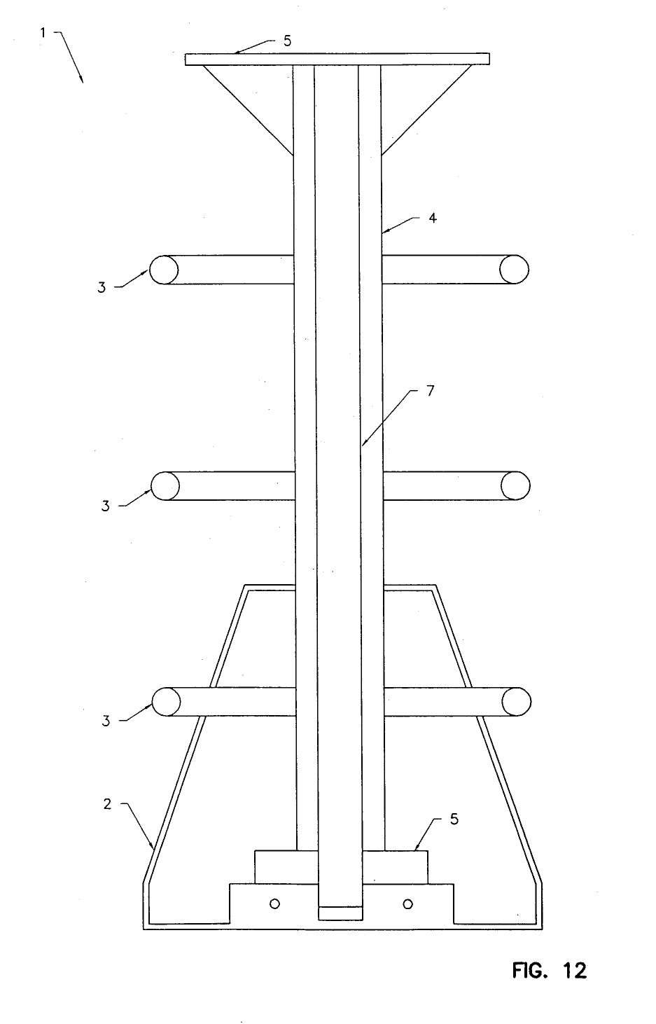

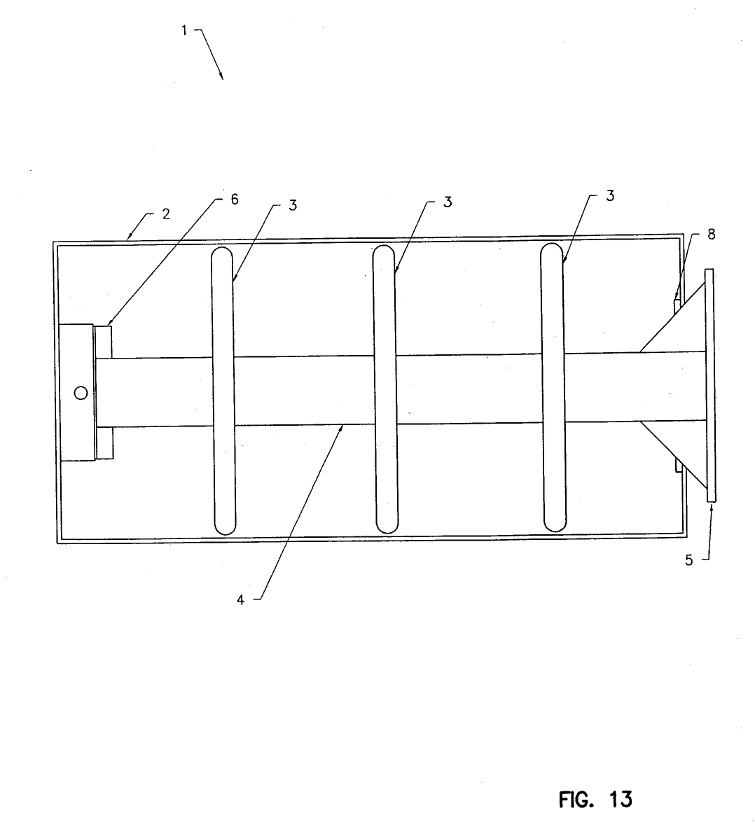

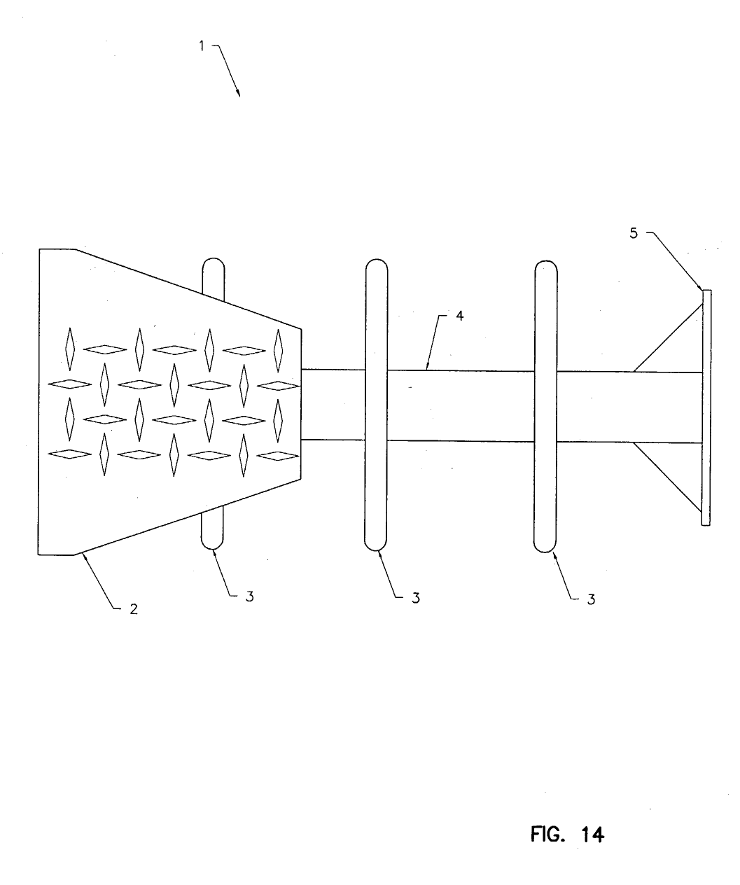

FIG. 7 shows the support tube and frame 4 that is attached to the mount plate 5 by welding and using gussets for extra support. FIG. 7 also illustrates the front plate 6, which is used to secure the lid with use of a padlock.

FIG. 13 shows the sliding lid securing plate which attaches to the sliding lid 2 and the door rod guide 7.

The Slider Tire Chain Hanger is constructed from both steel and aluminum. Diamond plate aluminum is used for the single sliding lid 2. Steel is used for the chain hooks 3 support tube and frame 4 mount plate 5 front plate 6 door rod guide 7 and sliding lid securing plate 8

What I, Eugene W. Gros, claim as my invention is:

1. A tire chain hanger comprising:
A frame having first and second ends defining and axis extending between said ends: at least one steel rod attached to said frame between said ends for hanging tire chains therefrom:
A mount plate affixed to one of said ends of said frame, said mount plate adapted to mount the tire chain hanger to the frame of a motor vehicle;
A sliding lid extending between and laterally connected with said rod guide that said lid overlies said frame and said at least one steel rod, Wherein sliding lid laterally and pivotally to an open position to gain access to said at least one steel rod and being lateral to a closed position to block access to said at least one steel rod, whereby a locking device may be connected to the sliding lid securing plate through the padlock hole of said sliding lid securing plate and said sliding lid.

2. The tire chain hanger of claim 1 wherein the hanger needs no clearance space to open said sliding door to gain access to said tire chains.

3. The tire chain hanger of claim 1 wherein said at least one steel rod comprises three steel rods.

4. The tire chain hanger of claim 1 wherein said sliding door is formed from diamond plate aluminum

5. The tire chain hanger of claim 1 wherein said at least one steel rod being substantially U-shaped.

6. The tire chain hanger of claim 1 wherein said sliding door
